(19) United States
(12) Patent Application Publication
(10) Pub. No.: US 2003/0206550 A1
(43) Pub. Date: Nov. 6, 2003

(54) Methods and apparatus for increasing the number of UTOPIA ports in an ATM device

(75) Inventor: Timothy M. Shanley, Orange, CT (US)

Correspondence Address: Gordon & Jacobson, P.C., 65 Woods End Road, Stamford, CT, 06905, US

(73) Assignee: TranSwitch Corporation

(21) Appl. No.: 10/135,681

(22) Filed: Apr. 30, 2002

(51) Int. Cl. H04L 12/28; H04L 12/56

(52) U.S. Cl. 370/395.1; 370/419

(57) ABSTRACT

Methods for increasing the number of UTOPIA ports in an ATM device include multiplexing data for a plurality of UTOPIA PHY ports over a first UTOPIA PHY port and providing backpressure information to the ATM device via a second UTOPIA PHY port. The backpressure information is preferably formatted in a single 56-byte UTOPIA cell. The presently preferred apparatus includes a sixty-four port UTOPIA Level 2 interface for coupling to up to sixty-four PHY devices, a two port UTOPIA Level 2 interface for coupling to the ATM device, and various buffers and controllers for controlling the flow of data between the two UTOPIA Level 2 interfaces. One of the ports in the two port UTOPIA Level 2 interface is used for configuration and control and the other is used for data.

This application is related to co-owned application Ser. No. --/----,---, filed on an even date herewith, entitled “Method and Apparatus for Avoiding Head of Line Blocking in in ATM (Asynchronous Transfer Mode) Device, the complete disclosure of which is incorporated by reference herein.

### BACKGROUND OF THE INVENTION

1. Field of the Invention

The present invention relates to telecommunications. More particularly, the present invention relates to the passing of high speed Asynchronous Transfer Mode (ATM) data or packet data over a standardized Universal Test and Operations Physical Interface for ATM (UTOPIA) bus.

2. State of the Art

ATM provides a mechanism for removing performance limitations of local area networks (LANs) and wide area networks (WANs) and provides data transfers at a speed of on the order of gigabits/second. Within the ATM technology, a commonly used interface specification between chips on a board for passing ATM cells is the UTOPIA (Universal Test & Operations PHY Interface for ATM) interface. The UTOPIA interface is specified in ATM Forum standard specifications, including: af-phy-0017.000 (UTOPIA Level 1, Version 2.01 Mar. 21, 1994); af_phy_{—}0039.000 (UTOPIA Level 2, Version 1, June 1995); and af-phy-00136.000 (UTOPIA 3 Physical Layer Interface November 1999) which are hereby incorporated by reference herein in their entireties. A typical application of the UTOPIA interface is supporting the connection between an ATM network processor and various PHY devices such as a DSL chip set and/or a SONET framer. UTOPIA is also used as the interface between a switch fabric and an ATM network processor.

UTOPIA supports three operation modes: single PHY operation mode, Multiple PHY (MPHY) with Direct Status Indication operation mode and MPHY with Multiplexed Status Polling operation mode. In the single PHY mode, the UTOPIA interface includes a data bus and a control bus. The operation of UTOPIA in the single PHY mode is relatively simple and straightforward. In MPHY operation mode, the UTOPIA interface includes a data bus, a control bus and an address bus. MPHY with Multiplexed Status Polling is used in most applications.

The MPHY UTOPIA transmit interface includes the following signals: transmit data (TxData); transmit address (TxAddr); and the transmit control signals transmit cell available (TxClav), transmit enable (TxEnb*) and transmit start of cell (TxSOC). The receive interface includes the following signals: receive data (RxData); receive address (RxAddr); and the receive control signals receive cell available (RxClav), receive enable (RxEnb*) and receive start of cell (RxSOC). A MPHY device may consist of multiple PHY ports, each PHY port having a one-to-one correspondence with a PHY Port address that is related to a UTOPIA address and Clav (Cell buffer available) signal.

Prior art FIG. 1 illustrates an example of a UTOPIA Level 2 interface supporting MPHY with Multiplexed Status Polling operation. As shown in FIG. 1, a transmit clock signal (TxClk) is used to clock control signals and data signals in the transmit direction (from the ATM device to the PHY devices). The TxData[15:0] signal is a 16-bit UTOPIA transmit data bus. The assertion of TxEnb* is coincident with the start of the cell transfer. TxSOC is used to indicate the start of cell position. TxClav is used to indicate that the PHY layer device is ready to receive a cell from the ATM layer device. TxAddr[4:0] is the UTOPIA address and is used to poll and select the appropriate MPHY device.

At the UTOPIA transmit interface, the ATM layer device polls the TxClav status of a PHY layer device by placing a specified address on the TxAddr bus for one clock cycle. The PHY layer device which is associated with the address on the TxAddr bus drives TxClav high (or low) during the next clock cycle during which the ATM device places a null address (1F) on the TxAddr bus. The ATM layer device checks TxClav at a certain time after it issues TxAddr. Based on polled TxClav information, the ATM layer device can select a PHY device and transfer data to this PHY device by driving TxEnb* and TXSOC signals.

Similarly, RxClk is the receive clock signal that is used to clock control signals and data in the receive direction (from the PHY device to the ATM device). RxData[15:0] is a 16-bit UTOPIA Receive bus. The assertion of RxEnb* is coincident with the start of the cell transfer. RxSOC is used to indicate the start of cell position. RxClav is used to indicate that the PHY layer device is ready to Receive a cell from the ATM layer device. RxAddr[4:0] is the UTOPIA address of the PHY device and is used by the ATM device to poll and select the appropriate PHY device in the receive direction.

At the UTOPIA receive interface, the ATM layer device polls the RxClav status of a PHY layer device by placing a specified address on RxAddr bus for one clock cycle. The PHY layer device which is associated with the address on the RxAddr bus drives RxClav high (or low) during the next clock cycle during which the ATM device places a null address (1F) on the RxAddr bus. The ATM layer device checks RxClav at a certain time after it issues RxAddr. Based on polled RxClav information, the ATM layer device can select a PHY device and receive data from this PHY device by driving the RxEnb* signal.

The number of PHY ports supported by a UTOPIA interface is generally fixed in the design of the device incorporating the UTOPIA interface. For example, the ASPEN® access processor device from Transwitch Corporation, Shelton, Conn. provides a UTOPIA interface for sixteen PHY layer devices to a CellBus® ATM switch.

In certain applications, it is desirable to use a particular ATM device which does not provide the desired number of UTOPIA PHY ports. In these situations, it would be desirable to provide a way to increase the number of PHY ports without significantly altering the ATM device.

### SUMMARY OF THE INVENTION

It is therefore an object of the invention to provide methods and apparatus for increasing the number of UTOPIA PHY ports in an ATM device.

It is also an object of the invention to provide methods and apparatus for increasing the number of UTOPIA PHY ports in an ATM device without significantly modifying the device.

In accord with these objects which will be discussed in detail below, the methods of the present invention include multiplexing up to sixty-four UTOPIA PHY ports over a single UTOPIA PHY port. In order to prevent cell loss, the methods of the invention include providing backpressure information to the ATM device via a dedicated UTOPIA PHY port. The backpressure information is preferably formatted in a single 56-byte UTOPIA cell.

The presently preferred apparatus of the invention includes a sixty-four port UTOPIA Level 2 interface for coupling to up to sixty-four PHY devices, a two port UTOPIA Level 2 interface for coupling to the ATM device, and various buffers and controllers for controlling the flow of data between the two UTOPIA Level 2 interfaces. One of the ports in the two port UTOPIA Level 2 interface is used for configuration and control and the other is used for data. The various buffers and controllers include three rate decoupling FIFOs, a congestion status cell buffer, a multicast session table, an enqueueing control, an SRAM control, and a round robin scheduler with queue status. The apparatus is preferably implemented as a field programmable gate array (FPGA) or application specific integrated circuit (ASIC) and is provided with an external (32K×32) SRAM as well as inlet and outlet clocks.

Data entering the apparatus through the sixty-four port UTOPIA interface is buffered in a four cell rate decoupling FIFO (RDF). When a cell enters the RDF, a two byte routing tag is prepended to the front of the cell identifying the source port ID. The ATM device is immediately notified (as soon as the entire cell has been stored) that a cell is available to be read out from the RDF. Cells written into the RDF are preferably immediately available to be clocked out to the ATM device. Preferably, UTOPIA address 0 is used for the data port and UTOPIA address 1 is used for the control port. This insures control path integrity under heavy traffic load conditions. If the RDF fills, the sixty-four port UTOPIA interface is notified to stop requesting cells from the PHYs until a cell slot becomes available in the RDF.

According to an embodiment of the invention, the ATM device is provided with sufficient RAM and programmed to maintain 256 unicast service category queues (4 per port), and 256 multicast queues. The ATM device is also programmed to maintain a congestion table which indicates congestion status for the multicast queue, and unicast queues. The invention is illustrated with reference to the aforementioned ASPEN® ATM device. The cells entering the ASPEN® ATM device from the CellBus® interface are automatically enqueued by a Tandem Routing Header. Using outlet queue state and the congestion status supplied by the apparatus of the invention, the ASPEN® rate processor (RP) dequeues cells toward apparatus of the invention. The cells pass through the outbound processor (OP) where they go through connection table lookup, header translation, and statistics maintenance before having a routing tag prepended for use by apparatus of the invention. The apparatus of the invention uses the routing tag for final port queuing before forwarding traffic to the appropriate PHY device.

Additional objects and advantages of the invention will become apparent to those skilled in the art upon reference to the detailed description taken in conjunction with the provided figures.

### BRIEF DESCRIPTION OF THE DRAWINGS

FIG. 1 is a simplified block diagram of a prior art UTOPIA interface;

FIG. 2 is a simplified block diagram of an apparatus according to the invention;

FIG. 3 is a simplified block diagram of an apparatus according to the invention together with an ASPEN® ATM device and associated RAM; and

FIG. 4 is a high level block diagram illustrating how the principles of the invention may be applied to any ATM layer device to increase the number of UTOPIA ports so that more PHY devices may be serviced.

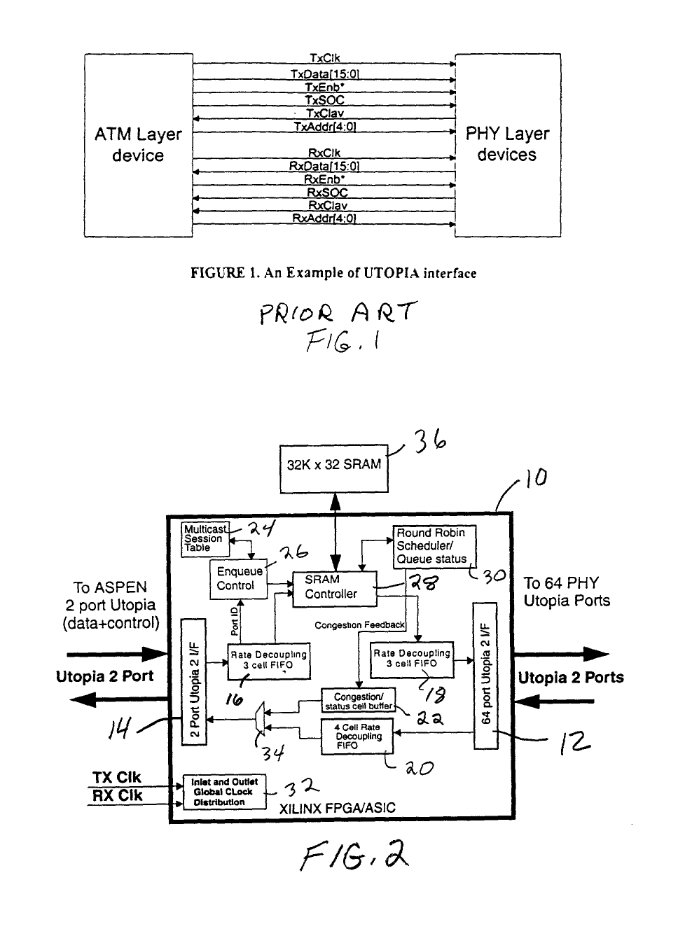

### BRIEF DESCRIPTION OF THE APPENDIX

The attached appendix is a document entitled “ASPEN-PX Device ASPEN® Port Expander TXC-05811 Data Sheet Product Preview”, dated January 2002, 48 pages. In accordance with the Code of Federal Regulations, the appendix is submitted as a CDROM.

The enclosed CD-ROM appendix is incorporated herein by reference. The CD-ROM is in ISO 9660 Macintosh® format and includes the following Adobe® Acrobat® files:

| List of files | Size (Bytes) | Date of Creation |
|---|---|---|
| apxdatasheet.pdf | 944,271 | Jan. 18, 2002 |

### DETAILED DESCRIPTION OF THE PREFERRED EMBODIMENTS

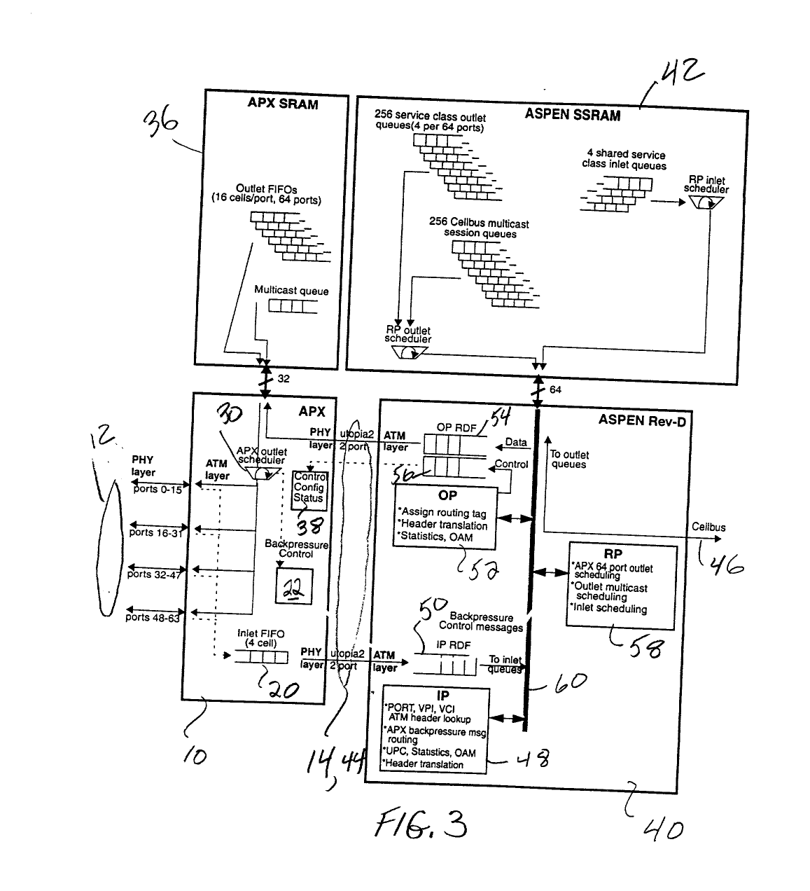

Referring now to FIG. 2, a UTOPIA port expander 10 according to the invention includes a sixty-four port UTOPIA Level 2 interface 12 for coupling to up to sixty-four PHY devices and a two port UTOPIA Level 2 interface 14 for coupling to an ATM device. The presently preferred port expander also includes three rate decoupling FIFOS 16, 18, 20, a congestion status cell buffer 22, a multicast session table 24, an enqueueing control 26, an SRAM control 28, a round robin scheduler with queue status 30, an inlet and outlet global clock distributor 32, and a multiplexer 34. The apparatus 10 is preferably provided with external (32K×32) RAM 36 as well as transmit and receive clock sources (not shown). The sixty-four port UTOPIA Level 2 interface 12 receives input from the three cell rate decoupling FIFO 18 and provides output to the four cell rate decoupling FIFO 20. The two port UTOPIA Level 2 interface 14 receives input from both the four cell rate decoupling FIFO 20 and the congestion/status cell buffer 22 via the multiplexer 34 and provides output to the three cell rate decoupling FIFO 16. The enqueuing control 26 receives port ID from the FIFO 16 and communicates with the multicast session table 24 as described in the previously incorporated co-owned application. The FIFO 16 and the enqueuing control 26 provide input to the SRAM controller 28 which is coupled to the external RAM 36 where individual queues are set up as described in more detail below with reference to FIG. 3. The SRAM controller 28 communicates with the round robin scheduler and queue status 30 which schedules cells from queues to the rate decoupling FIFO 18 and delivers backpressure information cells to the congestion status cell buffer 22.

For the purpose of discussion herein, data flow in the direction from the sixty-four port UTOPIA Level 2 interface 12 to the two port UTOPIA Level 2 interface 14 shall be referred to as the “upstream” data flow and data flow in the opposite direction shall be referred to as the “downstream” data flow.

Turning now to FIG. 3, the UTOPIA port expander 10 according to the invention is illustrated together with an ASPENE ATM device 40 and associated RAM 36, 42. The ASPEN® ATM device 40 includes a sixteen port UTOPIA Level 2 interface 44, a CellBus® interface 46, an inbound processor 48 with an associated rate decoupling FIFO 50, an outbound processor 52 with two associated rate decoupling FIFOs 54, 56, a rate processor 58 and an internal bus 60. Two of the sixteen UTOPIA ports 44 are coupled to the two port UTOPIA interface 14 of the apparatus 10. Preferably, UTOPIA address 0 is used for the data ports and UTOPIA address 1 is used for the control ports. The CellBus® interface 46 is used to couple the ASPEN® ATM device 40 to one or more other ATM devices (not shown). The inbound processor 48 is responsible for header lookup, header translation, backpressure message routing, usage parameter control (UPC), statistics, and overhead and maintenance (OAM). The outbound processor 52 is responsible for header translation, assignment of routing tags, statistics and OAM. The rate processor 58 is responsible for inlet scheduling, outlet multicast scheduling, and outlet scheduling for the sixty-four ports 12.

According to an embodiment of the invention, the ASPEN® ATM device 40 is provided with sufficient RAM 42 and programmed to maintain 256 unicast service category outlet queues (four per port, each of the four representing a different class of service), 256 multicast outlet queues, and four shared service class inlet queues. The ASPEN® ATM device 40 is also programmed to maintain a congestion table (not shown) which indicates congestion status for the downstream multicast queues and unicast queues in the RAM 36 of the port expander device 10.

Upstream data from all of the ports 12 is buffered in the four cell rate decoupling FIFO 20. When a cell enters the FIFO 20, a two byte routing tag is prepended to the front of the (fifty-four byte) cell identifying the source port ID. Although the tag is two bytes, the first ten bits are padded zeros and the last six bits identify one of the sixty-four (0-63) ports. The ASPEN® ATM device 40 is immediately notified (as soon as the entire cell has been stored in the FIFO 20) that a cell is available to be read out from the FIFO 20. Cells written into the FIFO 20 are preferably immediately available to be clocked out to the ASPEN® ATM device 40. If the FIFO 20 fills, the sixty-four port UTOPIA interface is notified to stop requesting cells from the PHYs until a cell slot becomes available in the FIFO 20. Upstream data enters the ASPEN® ATM device 40 to the rate decoupling FIFO 50 and passes through the inlet processor 48. The inlet processor 48 forwards backpressure messages to the rate processor 58, discards cells which were misdelivered. The inlet processor 48 also reads the cell header ionformation and forwards cells to the appropriate PHY via the CellBus® switch fabric 46.

Data in the downstream direction from the CellBus® interface 46 is automatically enqueued by a Tandem Routing Header pursuant to the CellBus® protocol. Based on outlet queue state and the congestion status supplied by the backpressure control 22, the rate processor 58 dequeues cells from the RAM 42 to the rate decoupling FIFO 54. The cells pass through the outbound processor 52 where they go through connection table lookup, header translation, and statistics maintenance before having a two-byte routing tag (or multicast session ID) prepended. The apparatus 10 of the invention uses the routing tag (or multicast session ID) for final port queuing before forwarding traffic to the appropriate PHY device. The two-byte tag used in the downstream direction is similar but not identical in format to the tag used in the upstream direction. In both the downstream and upstream direction, the six least significant bits of the second byte of the two-byte tag indicate the PHY ID. In the downstream direction, the least significant bit of the first byte of the tag is a multicast indicator. If that bit is set to “1”, all eight bits of the second byte are used for the multicast session ID.

According to the invention, the two port UTOPIA interface 14 of the UTOPIA port expander 10 acts in slave mode to the master mode of the UTOPIA interface 44 of the ASPEN® ATM device 40. The UTOPIA interface 12 of the apparatus 10 acts in master mode relative to the PHY devices (not shown).

As mentioned above, the apparatus 10 periodically generates a backpressure message which is formatted in a (fifty-six byte) UTOPIA cell. Table 1 below illustrates the format of the backpressure message.

TABLE 1

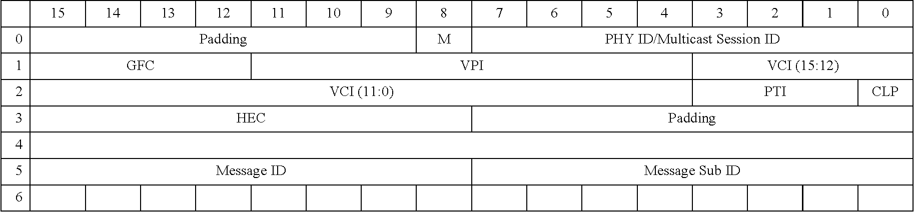

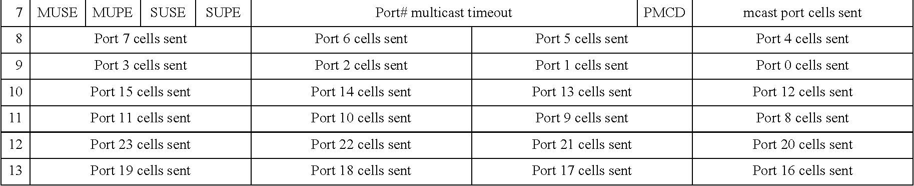

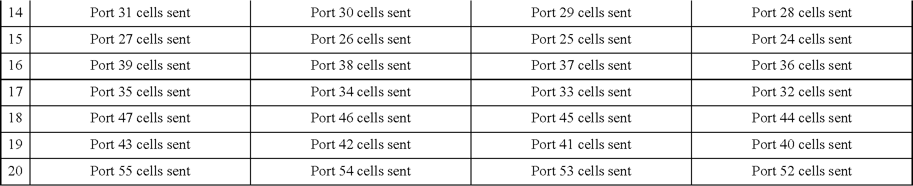

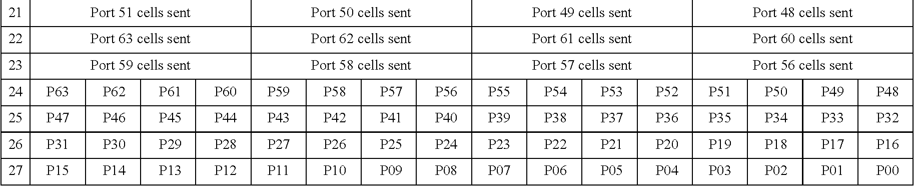

As illustrated in Table 1, the first word (0) of the UTOPIA cell includes the PHY address or the multicast session ID as described above. The next five words (1-5) of the cell contain ATM routing information. Word (6) is not used. Word (7) includes one bit indicators for MUSE, MUPE, SUSE, and SUPE, a seven bit Port# multicast timeout, a one bit PMCD indicator and a four bit indicator of multicast port cells sent. MUSE refers to “Master Utopia SOC error(s)” occurred. This bit remains asserted until the host clears the SOC counter. MUPE refers to “Master Utopia Parity error(s)” occurred. This bit remains asserted until the host clears the parity counter. SUSE refers to “Slave Utopia SOC error(s)” occurred. This bit remains asserted until the host clears the SOC counter. SUPE refers to “Slave Utopia Parity error(s)” occurred. This bit remains asserted until the host clears the parity counter. The Port# multicast timeout identifies the last port number to experience a multicast timeout error. Port numbers 0-3Fh are valid port numbers. Port number 7Fh indicates that no discard occurred between the last two backpressure messages. PMCD refers to “Port multicast discard(s)” occurred. This bit remains asserted until host clears the multicast discard counter.

The “mcast port cells sent” is a 4-bit rollover counter that increments each time a cell is dequeued downstream. Similarly, words (8) through (23) of the cell contain 4-bit rollover counters for each of the sixty-four downstream port queues. The ASPEN® scheduler in the rate processor (58 in FIG. 3) maintains its “sent” counts and compares them to the counts provided in the backpressure cells to determine the port queue fill levels. These counters are also be incremented if a cell is discarded due to congestion. They each have an initial value=0.

Words (24) through (27) of the cell include one bit cell discard indicators for each of the sixty-four downstream ports. These bits are asserted when a port discards a cell and remain asserted until the host clears the discard counter associated with the port.

Backpressure cells are generated periodically by the apparatus (10 in FIG. 3) to support a closed-loop scheduler between the ASPEN® device 40 and the downstream UTOPIA ports (12 in FIG. 3). The UTOPIA port expander (10 in FIG. 3) is designed to handle up to 8 Mb/s data rates for each of the sixty-four ports. A worst case analysis with a maximum data rate of 10 Mb results in a cell transfer rate of approximately 23,585 cells per second which is approximately 42.4×10⁻⁶ seconds per cell. With a buffer of 16 cells deep for each port, a backpressure message update should be sent every 8 cells or 339×10⁻⁶ seconds.

Backpressure cells are sent to the ASPEN® device through UTOPIA port 1 with a PHY ID=00h, an ATM header of unassigned cell (VPI=0, VCI=0, CLP=0), Message ID=0, and Message Sub ID=0.

As mentioned above, configuration, control, and status communication is also passed through UTOPIA port 1 via the outbound processor (52 in FIG. 3). These messages are also contained in 56-byte UTOPIA cells and their format is set out in the attached appendix.

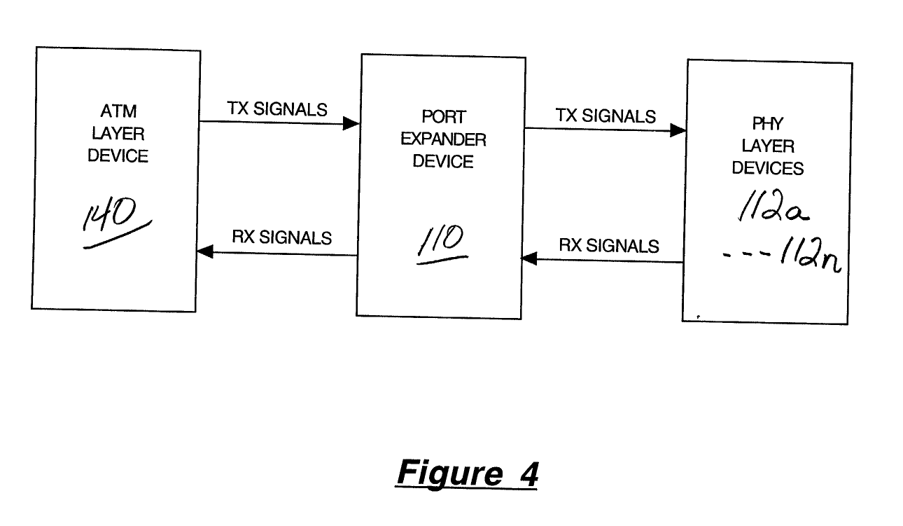

Referring now to FIG. 4, those skilled in the art will appreciate that the methods and apparatus of the invention can be applied to virtually any ATM layer device to increase the number of UTOPIA ports of the device. FIG. 4 illustrates how a port expander device 110 according to the invent can be coupled to an ATM layer device 140 and a plurality of PHY devices 112a-112n. The ATM layer device 140 (e.g. ATM traffic processor) will typically include a plurality of ATM traffic queues (not shown) which do not utilize the previously described tandem routing header and a switch fabric (not shown) which does not utilize the previously described CellBus® technology. The device 140 will typically also include upstream and ddownstream cell processors (not shown) which are different from the inbound and outbound processors of the previously described ASPEN® device and an ATM cell scheduler (not shown) which is different from the rate processor of the previously described ASPEN® device.

There have been described and illustrated herein methods and apparatus for increasing the number of UTOPIA ports in an ATM device. While particular embodiments of the invention have been described, it is not intended that the invention be limited thereto, as it is intended that the invention be as broad in scope as the art will allow and that the specification be read likewise. Thus, while particular hardware and software have been disclosed, it will be appreciated that other hardware and software could be utilized so long as the functional requirements of the invention are met. Also, while the apparatus of the invention has been shown in conjunction with an ASPEN® ATM device, it will be recognized that the invention could be used to increase the number of UTOPIA ports in other types of ATM devices. Moreover, while particular configurations have been disclosed in reference to the number of UTOPIA ports provided by the invention, it will be appreciated that other configurations could be used as well to support more or fewer ports. It will therefore be appreciated by those skilled in the art that yet other modifications could be made to the provided invention without deviating from its spirit and scope as so claimed.

1. A method for increasing the number of UTOPIA ports in an ATM device, said method comprising:
a) multiplexing data for n ports over a first UTOPIA PHY port from the ATM device; and
b) providing backpressure information for each of the n ports over a second UTOPIA PHY port to the ATM device.

2. The method according to claim 1, wherein:
n=sixty-four.

3. The method according to claim 1 ( wherein:
the backpressure information is formatted in a UTOPIA cell.

4. The method according to claim 1, further comprising:
c) providing a buffer for each of the n ports.

5. The method according to claim 4, wherein:
the backpressure information includes an indication of the number of cells dequeued from each buffer.

6. The method according to claim 5, wherein:
the backpressure information includes an indication of the number of cells discarded from each of the buffers.

7. The method according to claim 4, further comprising:
d) providing a single multicast buffer to be shared by up to n number of the n number of ports.

8. The method according to claim 7, wherein:
the backpressure information includes an indication of the number of cells dequeued from the multicast buffer.

9. The method according to claim 7, wherein:
the backpressure information includes an indication of whether a cell in the multicast buffer has been discarded.

10. The method according to claim 7, wherein:
the backpressure information includes an identification of the last port to experience a multicast timeout error.

11. An apparatus for increasing the number of UTOPIA ports in an ATM device, said method comprising:
a) a first UTOPIA interface adapted to be coupled to n PHY devices;
b) a second UTOPIA interface adapted to be coupled to the ATM device, said second UTOPIA interface having a first port for receiving data from the ATM device and a second port for sending backpressure information about each of the n ports to the ATM device.

12. The apparatus according to claim 11, wherein:
n=sixty-four.

13. The apparatus according to claim 11, wherein:
the backpressure information is formatted in a UTOPIA cell.

14. The apparatus according to claim 11, further comprising:
c) n buffers, one buffer for each of the ports.

15. The apparatus according to claim 14, wherein:
the backpressure information includes an indication of the number of cells dequeued from each of the buffers.

16. The apparatus according to claim 15, wherein:
the backpressure information includes an indication of the number of cells discarded from each of the buffers.

17. The apparatus according to claim 14, further comprising:
d) a single multicast buffer to be shared by up to n number of the ports.

18. The apparatus according to claim 17, wherein:
the backpressure information includes an indication of the number of cells dequeued from the multicast buffer.

19. The apparatus according to claim 17, wherein:
the backpressure information includes an indication of whether a cell in the multicast buffer has been discarded.

20. The apparatus according to claim 17, wherein:
the backpressure information includes an identification of the last port to experience a multicast timeout error.
